(19) United States
(12) Patent Application Publication
(10) Pub. No.: US 2008/0275756 A1
(43) Pub. Date: Nov. 6, 2008

(54) Apparatus and method for analyzing business continuity, and computer product

(75) Inventors: Takeshi Ito, Kawasaki (JP); Tsutomu Furumoto, Kawasaki (JP); Etsuo Watanabe, Kawasaki (JP); Takashi Tada, Kawasaki (JP); Koichi Matsuda, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/987,901

(22) Filed: Dec. 5, 2007

(30) Foreign Application Priority Data
Dec. 7, 2006 (JP) 2006-330499

(51) Int. Cl. G06Q 10/00; G06F 17/40

(52) U.S. Cl. 705/10

(57) ABSTRACT

A business continuity analyzing apparatus includes a process-information extracting unit that extracts processes included in an operation to be analyzed, from a data configuration that forms an operation flowchart representing the operation; an association editing unit that edits association between the processes extracted by the process-information extracting unit and resources previously stored in a common resource master; and a diagram generating unit that generates an influence diagram based on the association edited by the association editing unit.

### BACKGROUND OF THE INVENTION

1. Field of the Invention

The present invention relates to a business continuity analyzing program and a business continuity analyzing apparatus that generate an influence diagram to analyze business continuity, and, more particularly to a business continuity analyzing program and a business continuity analyzing apparatus that efficiently generate an influence diagram based on an operation flowchart or business process flowchart.

2. Description of the Related Art

An operation flowchart or business process flowchart is typically drawn to visualize contents or flows of an operation or business process. Formally, the operation flowchart has been usually drawn manually or using a versatile graphic depicting program. However, a dedicated program (for example, programs described in Japanese Patent Application Laid-open Nos. 2003-308421 and 2006-48145) has been recently used to efficiently draw an operation flowchart of good quality in the growing number of cases.

Business enterprises have recently developed a business continuity plan (BCP) to continue businesses without interruption as far as possible in case of various risks. To develop the BCP, an influence diagram is generated to assess the ability of continuing the business and find a point to be improved.

The influence diagram for assessing the business continuing ability shows association between processes and resources that are required to continue the operations or business processes. The processes and resources required to continue the operations are substantially the same as those described in the operation flowchart or business flowchart. Therefore, the influence diagram is frequently generated with reference to the operation flowchart or business process flowchart.

However, when many influence diagrams are to be generated or many processes and resources are required to continue the operation or business process, the work of generating the influence diagrams with referring to the operation flowchart requires a lot of effort.

### SUMMARY OF THE INVENTION

It is an object of the present invention to at least partially solve the problems in the conventional technology.

According to an aspect of the present invention, a business continuity analyzing apparatus that generates an influence diagram for analyzing business continuity, the business continuity analyzing apparatus comprising: a process-information extracting unit that extracts processes included in an operation to be analyzed, from a data configuration that forms an operation flowchart representing the operation; an association editing unit that edits association between the processes extracted by the process-information extracting unit and resources that are previously stored in a storage unit; and a diagram generating unit that generates an influence diagram based on the association edited by the association editing unit.

According to another aspect of the present invention, a method for analyzing business continuity includes extracting, from a data configuration that organizes an operation flowchart representing an operation to be analyzed based and indicating processes to be performed successively for achieving the operation and resources required to continue the operation, the processes defining on the operation flowchart; editing association between the extracted process and the resource previously registered; and generating the influence diagram based on the edited association.

According to still another aspect of the present invention, a computer-readable recording medium stores therein a computer program that implements the above method on a computer.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an example of an operation flowchart;

FIG. 2 is an example of an influence diagram;

FIG. 3 is a functional block diagram of a configuration of a business continuity analyzing apparatus according to the present invention;

FIG. 4 is an example of a data configuration of process data;

FIG. 5 is an example of a data configuration of resource data;

FIG. 6A is an example of a data configuration of relevant data;

FIG. 6B depicts relevant data after association edition;

FIG. 7 is an example of an association editing screen;

FIG. 8 is an example of a data configuration of a common resource master;

FIG. 9 is an example of a data configuration of a region master;

FIG. 10 is a flowchart of a process procedure of diagram generation;

FIG. 11 is an example of a recovery time editing screen;

FIG. 12 is an example of a data configuration of a scenario master; and

FIG. 13 is a functional block diagram of a computer that executes a business continuity analyzing program.

### DETAILED DESCRIPTION OF THE PREFERRED EMBODIMENTS

Exemplary embodiments of a business continuity analyzing program and a business continuity analyzing apparatus according to the present invention will be explained below in detail with reference to the accompanying drawings.

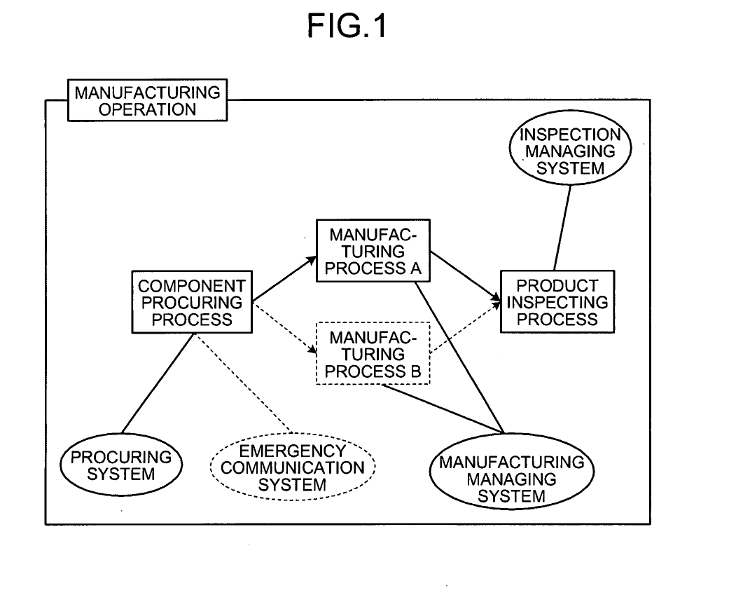

An operation flowchart or a business process flowchart and an influence diagram are explained first. FIG. 1 is an example of an operation flowchart or a business process flowchart. The operation flowchart shown in FIG. 1 depicts contents and flows of an operation called “manufacturing operation”. In FIG. 1, a rectangle denotes a process, and an ellipse denotes a resource. A rectangle and an ellipse in dotted lines denote an alternative process and an alternative resource, respectively.

The operation flowchart shown in FIG. 1 indicates that the “manufacturing operation” is achieved by successively performing three processes of a “component (or part) procuring process”, a “manufacturing process A”, and a “product inspecting process”. Instead of the “manufacturing process A”, a “manufacturing process B” can be executed.

FIG. 1 also indicates that the “component procuring process” requires a “procuring system” or an alternative “emergency communication system” as resources, the “manufacturing process A” and the “manufacturing process B” require a “manufacturing managing system” as a resource, and the “product inspecting process” requires an “inspection managing system” as a resource.

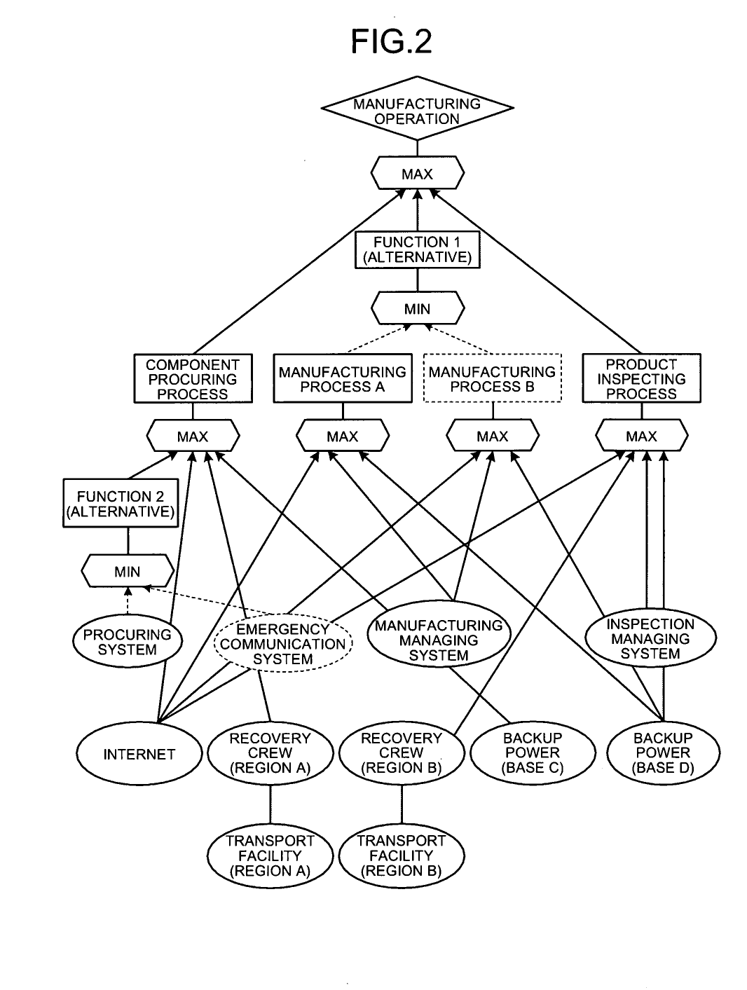

FIG. 2 is an example of an influence diagram. The influence diagram shown in FIG. 2 is used to assess a recovery time of an operation in case of a risk, and generated based on the operation flowchart shown in FIG. 1. In FIG. 2, a rhombus denotes an assessment node, a rectangle denotes a determinate node, an ellipse denotes an indeterminate node, and a hexagon denotes an efficacy node.

The assessment node assesses influences of a risk. The determinate node is controllable by a decision maker. The indeterminate node is uncontrollable by the decision maker. The efficacy node has prescribed efficacy. In this case, an efficacy node “MAX” that selects a maximum value and an efficacy node “MIN” that selects a minimum value are used.

When some risk occurs, the resources are directly affected by this risk. The recovery time of a process is the maximum value of recovery times of resources that are required by the process. In this case, the resources represented as the indeterminate nodes are connected to the determinant nodes of relevant processes through the efficacy node “MAX”.

The recovery time of the operation or business process for which the magnitude of influences of the risk is finally assessed is the maximum value of recovery times of processes that constitute the operation. The determinate nodes of the processes are connected to the assessment node representing the operation through the efficacy node “MAX”.

When the operation has alternative processes or resources, the function is achieved when one of the alternative processes or resources is recovered. The node representing the alternative process or resource is connected to an upper node through the efficacy node “MIN”.

In the case shown in FIG. 2, resources such as the “Internet” and a “backup power (base C)” that are not shown in the operation flowchart shown in FIG. 1 are shown as the indeterminate nodes, and connected to determinate nodes of relevant processes through the efficacy nodes.

Since the resources such as the “Internet” are not resources inherent in an individual operation or process, these resources are usually not shown in the operation flowchart. When the resources that are common to various operations are included in the operation flowchart of an individual operation or process, the operation flowchart becomes complicated. These common resources are, however, necessary to assess the recovery time and thus added to the influence diagram.

In the case shown in FIG. 2, a common resource of “transport facilities (Region A)” is connected to the efficacy node through a common resource of “Recovery crews (Region A)”. This indicates that recovery of the “transport facilities (Region A), which enables locomotion by the “transport facilities (Region A)”, is required as a premise of the recovery operation by the “recovery crew (Region A)”. In this case, the efficacy node must assess the recovery time of the “recovery crew (Region A)” as a sum of an original recovery time of the “recovery crew (Region A)” and a recovery time of the “transport facilities (Region A)”.

When such an influence diagram is generated, the recovery time of the operation in case of a risk can be obtained by calculation. Specifically, the recovery time (RT) of the “manufacturing operation” as shown in FIG. 2 is obtained by the following formula:

RT of the “manufacturing operation”

=MAX(RT of “Component procuring”, RT of “Function 1”, RT of “Product inspection”)

=MAX(MAX(RT of “Function 2”, RT of the “Internet”, RT of the “recovery crew (Region A)”+RT of the “transport facilities (Region A)”, RT of the “backup power (Base C)”), MIN(RT of the “manufacturing process A”, RT of the “manufacturing process B”), MAX(RT of the “inspection managing system”, RT of the “Internet”, RT of “recovery crew (Region B)”+RT of “transport facilities (Region B)”, RT of a “backup power (Base D)”))

=MAX(MAX(MIN(RT of the “procuring system”, RT of the “emergency communication system”, RT of the “Internet”, RT of the “recovery crew (Region A)”+RT of the “transport facilities (Region A)”, RT of the “backup power (Base C)”), MIN(MAX(RT of the “manufacturing managing system”, RT of the “Internet”, RT of the “backup power (Base D)”), MAX(RT of the “manufacturing managing system”, RT of the “Internet”, RT of the “backup power (Base D)”)), MAX(RT of the “inspection managing system”, RT of the “Internet”, RT of the “recovery crew (Region B)”+RT of the “transport facilities (Region B)”, RT of the “backup power (Base D)”))

A business continuity analyzing apparatus according to an embodiment of the present invention is explained. A business continuity analyzing apparatus 100 according to the embodiment generates an influence diagram shown in FIG. 2, based on the operation flowchart or business process flowchart shown in FIG. 1.

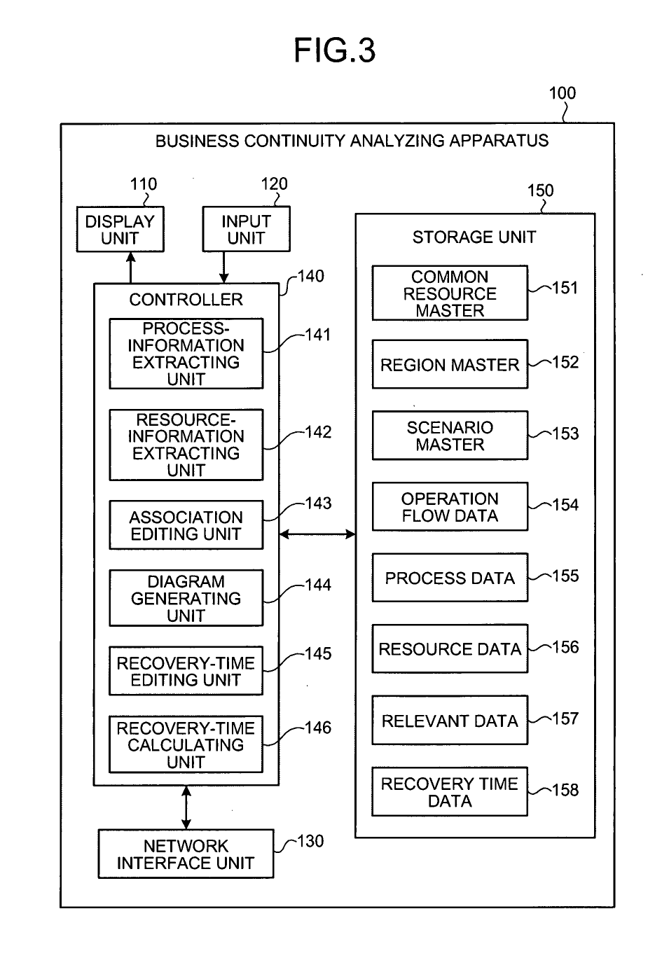

FIG. 3 is a functional block diagram of a configuration of the business continuity analyzing apparatus 100. As shown in FIG. 3, the business continuity analyzing apparatus 100 includes a display unit 110, an input unit 120, a network interface unit 130, a controller 140, and a storage unit 150.

The display unit 110 displays various kinds of information, and is equipped with a liquid crystal display or the like. The input unit 120 is equipped with a keyboard or a mouse, and the user inputs various instructions to the input unit 120. The network interface unit 130 is an interface for exchanging information with other devices through a network.

The controller 140 controls the entire business continuity analyzing apparatus 100. The controller 140 has a process-information extracting unit 141, a resource-information extracting unit 142, an association editing unit 143, a diagram generating unit 144, a recovery-time editing unit 145, and a recovery-time calculating unit 146.

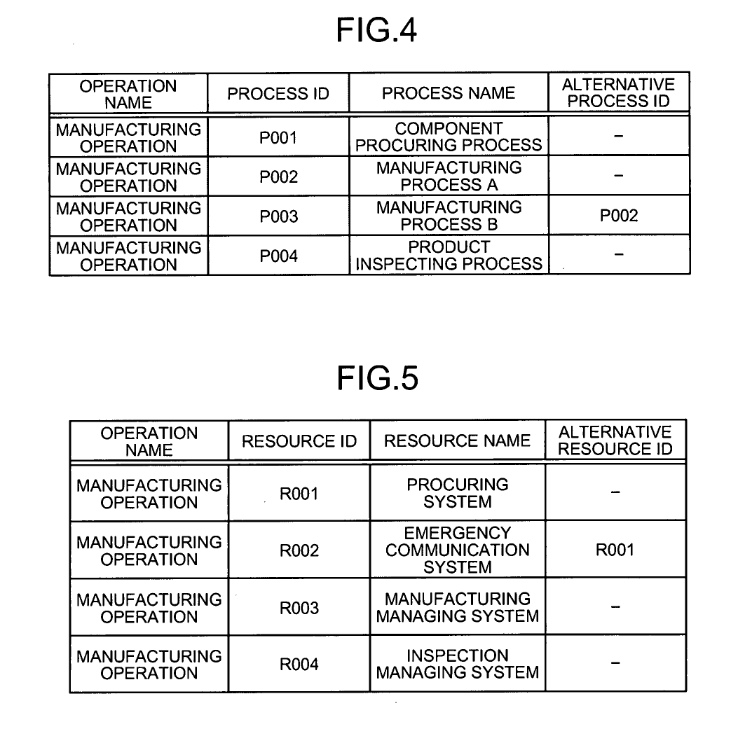

The process-information extracting unit 141 extracts information related to processes from a data configuration that represents an operation flowchart, stored in the storage unit 150 as operation flow data 154, and stores the extracted information in the storage unit 150 as process data 155. Exemplary process data 155 is shown in FIG. 4. FIG. 4 depicts a case that information related to processes is extracted from a data configuration that forms the operation flowchart shown in FIG. 1.

As shown in FIG. 4, the process data 155 has items including an operation name, a process ID, a process name, and an alternative process ID. The operation name is the name of an operation including processes. The process ID is used to identify a process. The process-information extracting unit 141 assigns a unique value as the process ID. The process name is the name of a process.

When a process is an alternative to another process, the process ID of this another process to be substituted for is set as the alternative process ID for the process. For example, a process named as “manufacturing process B” on the third line is an alternative to a process named as “manufacturing process A”. Therefore, for the alternative process ID of the “manufacturing process B”, the process ID “P002” of the “manufacturing process A” is set.

The resource-information extracting unit 142 extracts information related to resources from the data configuration that represents the operation flowchart stored as the operation flow data 154, and stores the extracted information in the storage unit 150 as resource data 156. Exemplary resource data 156 is shown in FIG. 5. FIG. 5 depicts a case that information related to resources is extracted from the data configuration that forms the operation flowchart shown in FIG. 1.

As shown in FIG. 5, the resource data 156 has items including an operation name, a resource ID, a resource name, and an alternative resource ID. The operation name is the name of an operation including resources. The resource ID is used to identify a resource. The resource-information extracting unit 142 assigns a unique value as the resource ID. The resource name is the name of a resource.

When a resource is an alternative to another resource, the resource ID of this another resource to be substituted for is set as the alternative resource ID of the resource. For example, a resource named as “emergency communication system” on the second line is an alternative to a resource named as “procuring system”. Therefore, a resource ID “R001” of the resource of the “procuring system” is set for the alternative resource ID of the “emergency communication system”.

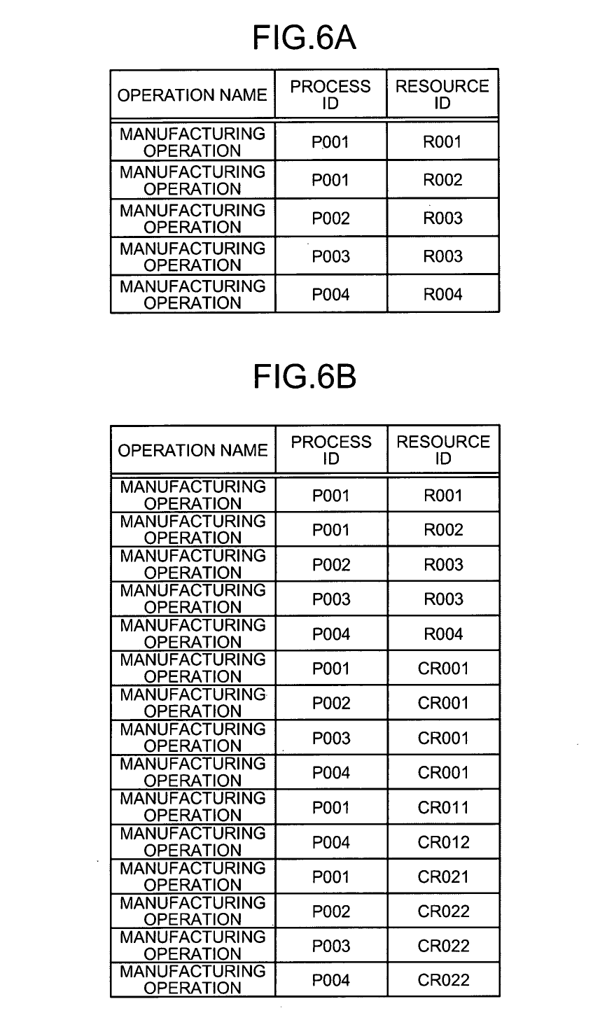

The resource-information extracting unit 142 extracts information related to association between processes and resources from the data configuration that forms the operation flowchart, and stores the extracted information in the storage unit 150 as relevant data 157. Exemplary relevant data 157 is shown in FIG. 6A. FIG. 6A depicts a case that information related to association between processes and resources is extracted from the data configuration that forms the operation flowchart shown in FIG. 1.

As shown in FIG. 6A, the relevant data 157 has items including an operation name, a process ID, and a resource ID. The operation name is the name of an operation including processes and resource. The process ID is used to identify a process, and corresponds to the process ID of the process data 155. The resource ID is used to identify a resource, and corresponds to the resource ID of the resource data 156.

As the relevant data 157, IDs of processes and resources that are associated together in the operation flowchart are registered in pairs. For example, the first line of the relevant data 157 shown in FIG. 6A indicates that a process named as “component procuring process” to which a process ID “P001” is assigned is associated with a resource named as “procuring system” to which a resource ID “R001” is assigned.

The association editing unit 143 displays an association editing screen on the display unit 110, edits association between processes extracted by the process-information extracting unit 141 and common resources registered in a common resource master 151 in the storage unit 150, and stores the edited association in the relevant data 157.

As described above, the common resources associated with the processes must be described in the influence diagram without omission. However, the common resources are usually not described in the operation flowchart. Therefore, the association editing unit 143 displays an association editing screen to the user to associate the previously registered common resources and the processes together.

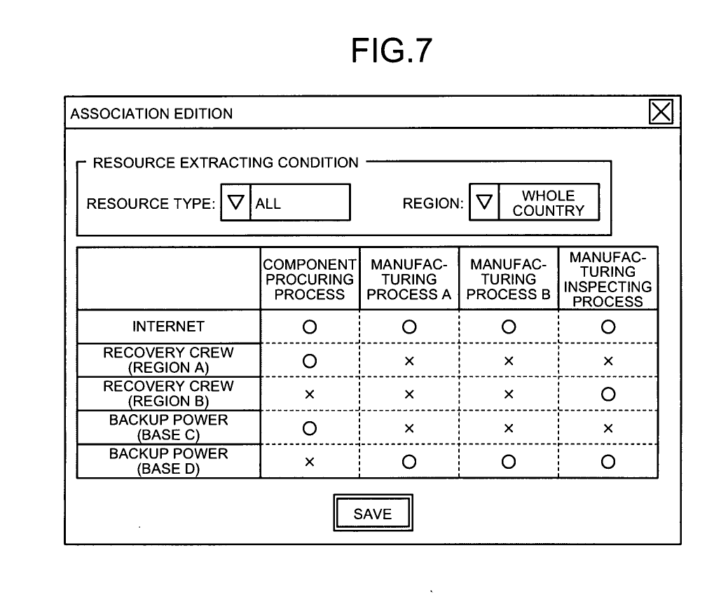

FIG. 7 is an example of an exemplary association editing screen. As shown in FIG. 7, the association editing screen includes an area for specifying conditions to extract common resources and an area for displaying a matrix of the common resources extracted on the specified conditions and processes to edit association.

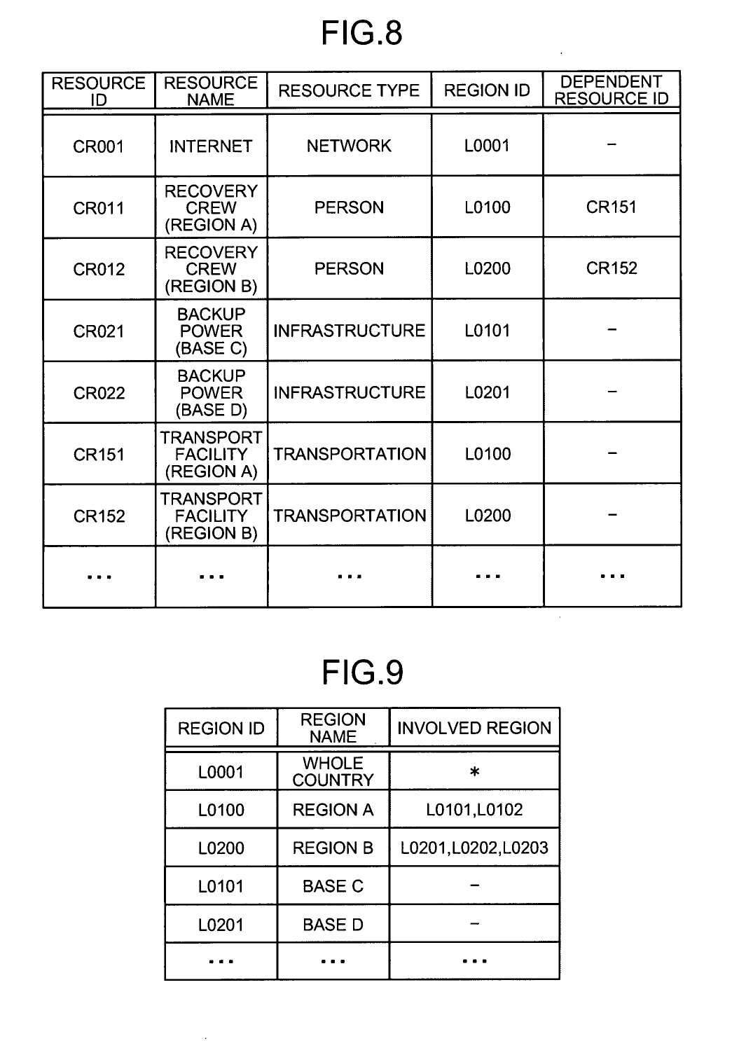

A data configuration of the common resource master 151 is shown in FIG. 8. As shown in FIG. 8, the common resource master 151 has items including a resource ID, a resource name, a resource type, a region ID, and a dependent resource ID. The resource ID is used to identify a common resource. The resource name is the name of a common resource.

The resource type indicates general characteristics of the common resource. Values such as “Network”, “Person”, “Infrastructure”, and “Transport” are set for the resource type. As the region ID, an ID indicating a region in which the common resource is shared is set. The region IDs correspond to region IDs of a region master 152 in the storage unit 150.

When before a recovery operation of a common resource, recovery of another common resource must be completed, the resource ID of this another common resource is set as the dependent resource ID of the common resource. For example, before a recovery operation of a common resource named as “recovery crew (Region A)” on the second line, completion of recovery of a common resource named as “transport facilities (Region A)” is needed. Therefore, the resource ID “CR151” of the common resource of the “transport facilities (Region A)” is set for the dependent resource ID of the “recovery crew (Region A)”.

FIG. 9 is an example of an exemplary data configuration of the region master 152. As shown in FIG. 9, the region master 152 has items including a region ID, a region name, and an involved region. The region ID is used to identify a region. The region name is the name of a region.

For the involved region, region IDs of other regions included in that region are set. For example, data on the second line indicates that a “region A” includes a region having a region ID “L0101” and a region having a region ID “L0102”. Data on the first line has a special value for the involved region. This indicates that a region named as “whole country” includes all regions.

On the association editing screen in FIG. 7, the resource type and the region name can be specified as extraction conditions for common resources to avoid a complicated screen because of vast numbers of common resources being displayed. Only common resources that conform to the specified conditions are extracted from the common resource master 151, and displayed in matrix to edit association between the resources and the processes.

When a save button is pressed on the association editing screen, combinations of IDs of processes and common resources for which “o” is set in the matrix (see FIG. 7) are stored in the relevant data 157, and combinations of IDs of processes and common resources for which “x” is set in the matrix (see FIG. 7) are deleted from the relevant data 157. The association editing result is shown in FIG. 6B.

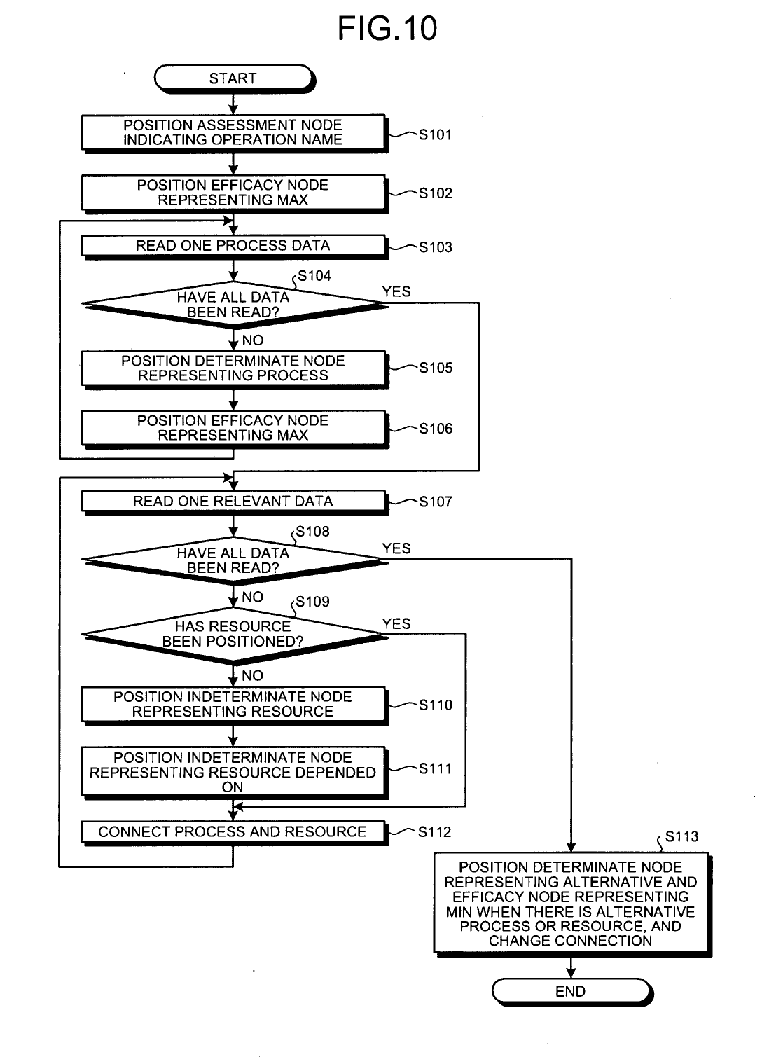

The diagram generating unit 144 generates an influence diagram based on the data stored in the storage unit 150. Processing steps of generating an influence diagram by the diagram generating unit 144 are shown in FIG. 10.

As shown in FIG. 10, the diagram generating unit 144 positions an assessment node that indicates the name of an operation (step S101), and positions an efficacy node representing MAX under the assessment node (step S102). The diagram generating unit 144 read one data from the process data 155 (step S103).

When data can be read (NO at step S104), the diagram generating unit 144 positions a determinate node given the process name of the read data (step S105), positions an efficacy node representing MAX under the determinant node (step S106), and returns to step S103 to try to read the next data.

When all data have been already read at step S103 (YES at step S104), the diagram generating unit 144 reads one data from the relevant data 157 (step S107).

When data can be read (NO at step S108), the diagram generating unit 144 confirms whether an indeterminate node given the resource name corresponding to the resource ID of the read data is positioned. When the indeterminate node is not positioned (NO at step S109), the diagram generating unit 144 positions the indeterminate node given the resource name corresponding to the resource ID of the read data (step S110). The diagram generating unit 144 then refers to the common resource master 151. When this resource is dependent on any resource, the diagram generating unit 144 positions an indeterminate node given the resource name of the resource on which this resource is dependent under the indeterminate node (step S111).

When the indeterminate node is newly positioned at step S110, this node is connected to a determinate node given the process name corresponding to the process ID of the read data. Otherwise, the existing indeterminate node given the resource name corresponding to the resource ID of the read data and the determinate node given the process name corresponding to the process ID of the read data are connect (step S112). The diagram generating unit 144 then returns to step S107 to try to read the next data.

When reading of all data from the relevant data 157 is completed (YES at step S108), the diagram generating unit 144 refers to the process data 155 and the resource data 156. When there is an alternative process or resource, the diagram generating unit 144 positions a determinate node representing an alternative and an efficacy node representing MIN to change connection (step S113).

Returning to FIG. 3, the recovery-time editing unit 145 displays a recovery time editing screen on the display unit 110, causes to input recovery times of resources that are required by the recovery-time calculating unit 146 to calculate the recovery time of the operation, and stores the inputted data in a recovery time data 158 in the storage unit 150.

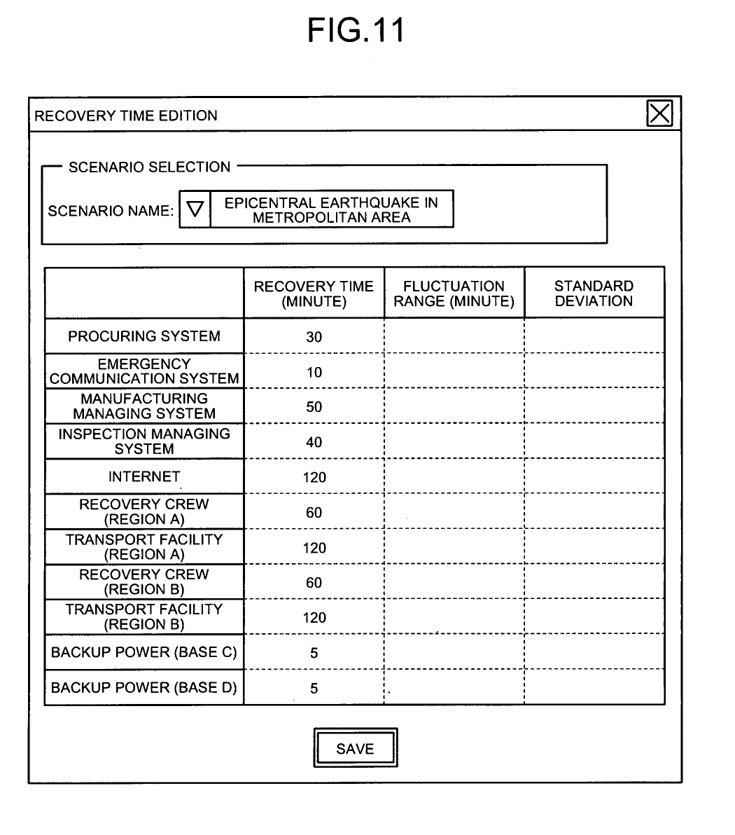

FIG. 11 is an example of an exemplary recovery time editing screen. As shown in FIG. 11, the recovery time editing screen includes an area for selecting a scenario, and an area for inputting a recovery time, a fluctuation range of the recovery time, and a standard deviation for each resource. In the area for selecting a scenario, names of scenarios that are stored in a scenario master 153 in the storage unit 150 are displayed as choices. The scenario means an event that causes one or plural risks, and for example includes an earthquake and fire.

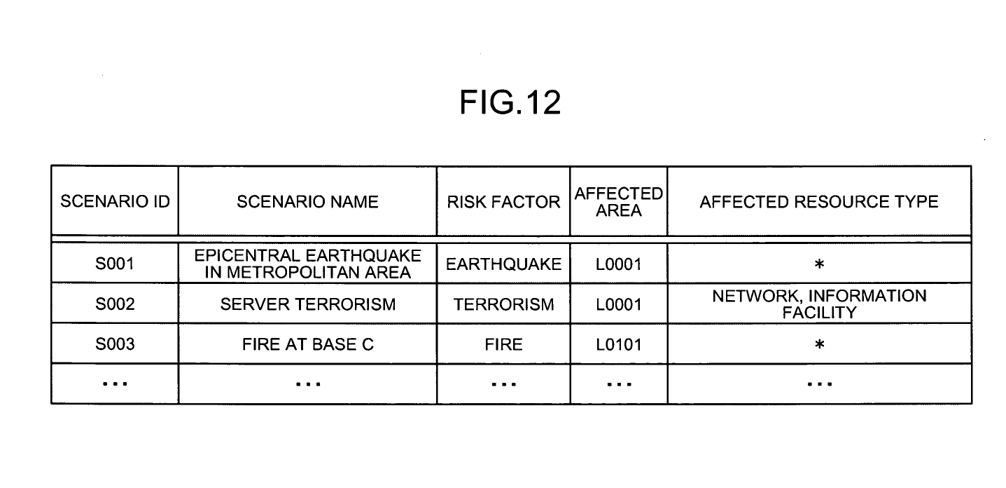

A data configuration of the scenario master 153 is shown in FIG. 12. As shown in FIG. 12, the scenario master 153 has items including a scenario ID, a scenario name, a risk factor, an affected area, and an affected resource type. The scenario ID is used to identify a scenario. The scenario name is the name of a scenario.

The risk factor indicates a risk that causes damage in a scenario. The affected region indicates a region in which damage occurs in the scenario. The affected resource type indicates the type of a resource that is damaged. Specifically, one or plural IDs corresponding to the region IDs in the region master 152 are set for the affected region. One or plural types corresponding to the resource types in the common resource master 151 are set for the affected resource type. When all types of resources are damaged in the scenario, “*” is set for the affected resource type.

When a scenario is selected in the area for selecting a scenario on the recovery time editing screen, the recovery-time editing unit 145 acquires values of the affected region and the affected resource type of the scenario from the scenario master 153. After resources stored in the resource data 156 are displayed in the area for inputting the recovery time and the like, common resources corresponding to the acquired affected regions and affected resource types are extracted from the common resource master 151, and displayed.

The recovery time editing screen is adapted to, when a scenario is selected, display a list of resources that are damaged in the selected scenario. Therefore, the user can set the recovery time and the like easily and certainly. There is no need to individually define a correspondence between the scenario and the resource to achieve this function. Only by specifying the affected regions and the affected resource types for each scenario, the user can restrict resources that are damaged in the scenario.

The recovery-time calculating unit 146 calculates a recovery time of the operation based on the data configuration of the influence diagram stored in the relevant data 157 and the like, and the recovery times of resources stored in the recovery time data 158.

When instructed to obtain the recovery time of the operation in a scenario, the recovery-time calculating unit 146 generates the formula as already shown, based on the data configuration of the influence diagram stored in the relevant data 157 and the like, acquires the recovery time of each resource in the specified scenario from the recovery time data 158, and assigns the acquired data to the generated formula to execute an arithmetic operation.

The calculation of the recovery time of the operation can be performed by simply assigning the recovery time of each resource to the formula or, in view of fluctuations in the recovery time of each resource, according to a Monte Carlo simulation or the like using a range of the fluctuations and the standard deviation. The recovery-time calculating unit 146 can analyze influences of improvement of the recovery time of each resource upon the recovery time of the operation, by a sensitivity analysis method.

The configuration of the business continuity analyzing apparatus 100 according to the present embodiment shown in FIG. 3 can be changed in various ways without departing from the spirit or scope of the present invention. For example, a function equivalent to the business continuity analyzing apparatus 100 can be achieved by mounting the function of the controller 140 of the business continuity analyzing apparatus 100 as software, and executing the software by a computer. An exemplary computer that executes a business-continuity analyzing program 1071 as software mounted thereon to realize the function of the controller 140 is explained below.

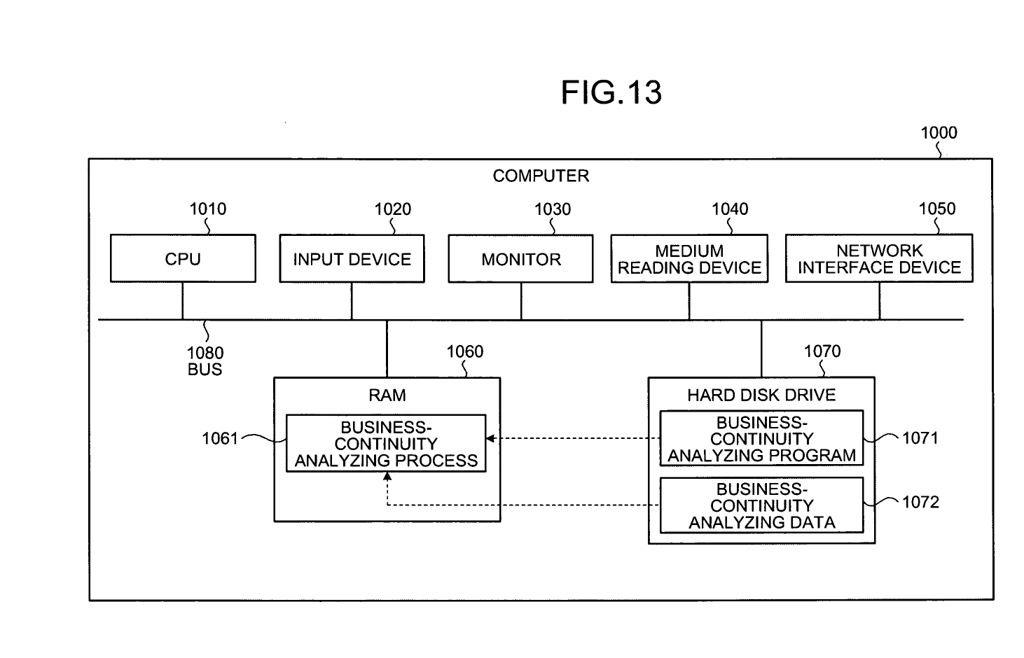

FIG. 13 is a functional block diagram of a computer 1000 that executes the business-continuity analyzing program 1071. The computer 1000 includes a central processing unit (CPU) 1010 that executes various arithmetic operations, an input device 1020 that receives input of data from the user, a monitor 1030 that displays various types of information, a medium reading device 1040 that reads a program and the like from a recording medium, a network interface device 1050 that sends or receives data to/from other computers through a network, a random access memory (RAM) 1060 that temporarily stores the various types of information, and a hard disk drive 1070, which are connected together via a bus 1080.

The hard disk drive 1070 stores the business-continuity analyzing program 1071 that has an equivalent function to the controller 140 shown in FIG. 3, and business-continuity analyzing data 1072 corresponding to various data stored in the storage unit 150 shown in FIG. 3. The business-continuity analyzing data 1072 can be properly distributed and stored in other local computers that are connected through the network.

When the CPU 1010 reads or fetches the business-continuity analyzing program 1071 from the hard disk drive 1070 and expands or stores the business-continuity analyzing program 1071 in the RAM 1060, the business-continuity analyzing program 1071 serves as a business-continuity analyzing process 1061. The business-continuity analyzing process 1061 properly expands or stores information that is read from the business-continuity analyzing data 1072 in an appropriate area allocated to the business-continuity analyzing process 1061 in the RAM 1060, and executes various data processing based on the expanded data.

The business-continuity analyzing program 1071 is not necessarily stored in the hard disk drive 1070. The business-continuity analyzing program 1071 can be stored in a storage medium such as a compact-disk read only memory (CD-ROM), then can be read and executed by the computer 1000. The business-continuity analyzing program 1071 can be stored in other computers (or servers) that are connected to the computer 1000 through a public network, the Internet, a local area network (LAN), a wide area network (WAN), or the like. In this case, the computer 1000 reads the business-continuity analyzing program 1071 from other computers, and executes the program.

As described above, in the present embodiment, a basic data configuration of the influence diagram is automatically generated based on the data configuration of the operation flowchart, and common resources previously registered can be associated therewith in a simple operation. Therefore, the influence diagram can be efficiently generated.

According to the present invention, processes included in an operation or work to be analyzed are extracted from an operation flowchart already drawn, and an influence diagram is automatically generated based on association between these processes and previously-registered resources. Therefore, the influence diagram of the operation to be analyzed can be generated efficiently.

According to the present invention, the influence diagram is generated by utilizing information of resources included in the operation flowchart already drawn. Therefore, the influence diagram of the operation to be analyzed can be generated more efficiently.

According to the present invention, a recovery time of the operation to be analyzed is calculated using a data configuration generated in the course of generating the influence diagram. Therefore, the business continuity of the operation to be analyzed can be analyzed efficiently.

According to the present invention, the magnitude of influences of fluctuations in the recovery time of each resource upon the recovery time of the operation is obtained based on sensitivity analysis. Therefore, a point to be improved that is effective in reducing the recovery time of the operation can be found easily.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A computer-readable recording medium that stores therein a computer program for analyzing business continuity, the computer program causing a computer to execute:
extracting, from a data configuration that organizes an operation flowchart representing an operation to be analyzed based and indicating processes to be performed successively for achieving the operation and resources required to continue the operation, the processes defining on the operation flowchart;
editing association between the extracted process and the resource previously registered; and
generating the influence diagram based on the edited association.

2. The computer-readable recording medium according to claim 1, wherein the computer program further causes the computer to execute extracting the resources included in the operation and the association between the processes and the resources, from the data configuration, wherein the influence diagram is generated based on the edited association and the extracted information.

3. The computer-readable recording medium according to claim 1, wherein the computer program further causes the computer to execute:
inputting a recovery time of each resource; and
calculating a recovery time of the operation based on the inputted recovery time of each resource and the information for generating the influence diagram.

4. The computer-readable recording medium according to claim 3, wherein the inputting the recovery time includes obtaining sensitivity of fluctuations in the recovery time of each resource that change the recovery time of the operation.

5. A business continuity analyzing apparatus that generates an influence diagram for analyzing business continuity, the business continuity analyzing apparatus comprising:
a process-information extracting unit that extracts processes included in an operation to be analyzed, from a data configuration that forms an operation flowchart representing the operation;
an association editing unit that edits association between the processes extracted by the process-information extracting unit and resources that are previously stored in a storage unit; and
a diagram generating unit that generates an influence diagram based on the association edited by the association editing unit.

6. The business continuity analyzing apparatus according to claim 5, further comprising:
a resource-information extracting unit that extracts resources included in the operation and association between processes and resources from the data configuration, wherein the diagram generating unit generates an influence diagram based on the association edited by the association editing unit and the information extracted by the resource-information extracting unit.

7. The business continuity analyzing apparatus according to claim 5, further comprising:
a recovery-time editing unit that inputs a recovery time of each resource; and
a recovery-time calculating unit that calculates a recovery time of the operation based on the recovery time of each resource inputted by the recovery-time editing unit and the information for generating the influence diagram.

8. The business continuity analyzing apparatus according to claim 7, wherein the recovery-time calculating unit obtains sensitivity of fluctuations in the recovery time of each resource that change the recovery time of the operation.

9. A method for analyzing business continuity, comprising:
extracting, from a data configuration that organizes an operation flowchart representing an operation to be analyzed based and indicating processes to be performed successively for achieving the operation and resources required to continue the operation, the processes defining on the operation flowchart;
editing association between the extracted process and the resource previously registered; and
generating the influence diagram based on the edited association.

10. The method according to claim 9, further comprising extracting the resources included in the operation and the association between the processes and the resources, from the data configuration, wherein the influence diagram is generated based on the edited association and the extracted information.

11. The method according to claim 9, further comprising:
inputting a recovery time of each resource; and
calculating a recovery time of the operation based on the inputted recovery time of each resource and the information for generating the influence diagram.

12. The method according to claim 11, wherein the inputting the recovery time includes obtaining sensitivity of fluctuations in the recovery time of each resource that change the recovery time of the operation.
